(19) United States
(12) Patent Application Publication
(10) Pub. No.: US 2023/0392868 A1
(43) Pub. Date: Dec. 7, 2023

(54) VERTICAL FURNACE FOR A CONTINUOUS HEAT TREATMENT OF A METAL STRIP

(71) Applicant: EBNER Industrieofenbau GmbH, Leonding (AT)

(72) Inventors: Robert EBNER, Leonding (AT); Sascha EPPENSTEINER, Engerwitzdorf (AT); Martin RECHBERGER, Prambachkirchen (AT)

(73) Assignee: EBNER Industrieofenbau GmbH, Leonding (AT)

(21) Appl. No.: 18/032,829

(22) PCT Filed: Oct. 20, 2021
(86) PCT No.: PCT/AT2021/060389

§ 371 Date: Apr. 20, 2023

(30) Foreign Application Priority Data
Oct. 21, 2020 (AT) A50904/2020

(51) Int. Cl. F27B 9/28; F27B 9/12; F27B 9/36; F27B 9/38; F27B 9/02; F27B 9/04; F27B 9/30

(52) U.S. Cl. CPC F27B 9/28; F27B 9/12; F27B 9/36; F27B 9/38; F27B 9/028; F27B 9/047; F27B 9/3005; F27B 2009/126; F27B 2009/3646; F27B 2009/382

(57) ABSTRACT

A vertical furnace for the continuous heat treatment of a metal strip, in particular for an electrical steel strip, as seen in the conveying direction of the metal strip, includes an inlet zone for the metal strip; a heating/holding zone with an annealing chamber for heating and holding the metal strip at a certain temperature; a first cooling zone for cooling the metal strip; and a deflection device, arranged downstream of the first cooling zone with at least one roller arrangement, for deflecting the metal strip in the direction of an outlet zone for the metal strip. At least one second cooling zone is arranged downstream of the deflection device with respect to the conveying direction.

The invention relates to a vertical furnace for the continuous heat treatment of a metal strip according to the preamble of claim 1.

Vertical furnaces for the heat treatment of strips are known in the prior art. When a strip is transported in the vertical conveying direction, heating of the strip to the treatment temperature and a subsequent annealing treatment are performed. Furthermore, a cooling of the strip and a transport back in the vertical conveying direction with the aid of a deflection are performed.

The disadvantage of vertical furnaces from the prior art is that after the heating, heat treatment and cooling processes, the strips often suffer damage in the area of the deflection due to thermal stresses and strains, its own weight and additional load from the deflection in this area, which can lead to a reduction in the strip quality and also the surface quality.

The object of the present invention was to overcome the shortcomings of the prior art and to provide a device, by means of which an improved quality of metal strip may be ensured.

This object is achieved according to the invention by the features of the characterizing part of claim 1, with a vertical furnace of the initially mentioned type.

The embodiment according to the invention entails the advantage that a metal strip can be deflected at a moderate temperature and be cooled to the target temperature only after the deflection and the damage in the area of the deflection device may be significantly reduced.

An additional advantage of this embodiment is that the height of the vertical furnace can be better utilized, since not all heating and cooling devices are arranged in front of the deflection device.

Advantageous further embodiments are indicated in the sub-claims.

It is particularly advantageous for the vertical furnace to have a protective gas atmosphere with a high H₂ content (30%-100% H₂) (vol. %) and low dew points (−20° C. to −70° C.), in the heating/holding zone, in the first cooling zone, in the deflection device and in the second cooling zone for heat treatment of the metal strip, in order to avoid oxidation. It has proven to be particularly advantageous that the entire heat treatment of the metal strip, in particular of the electrical steel strip, takes place in an inert gas atmosphere with a high H₂ content (30%-100% H₂) (vol. %) and low dew points (−20° C. to −70° C.) in order to avoid oxidation.

The furnace for the vertical heat treatment of metal strips, in particular of electrical steel strips, can comprise one or multiple heating stations, which can be insulated with a heat-insulating material, a single- or multi-part annealing chamber (with muffle or also muffle-less), which is filled with a high H2-containing protective gas atmosphere and is used for heating as well as for maintaining the temperature of the metal strip. The heating and/or holding zone may be heated by means of electrical energy (electric heating elements and/or induction heater) or by means of gas heating.

Furthermore, one or more cooling zones can be arranged downstream, which can be in connection with a gas supply unit. This is followed by an upper roller chamber, in which two guide rollers can be arranged, with which the running metal strip is guided and directed back into a vertical outlet channel.

It has been found to be particularly advantageous that the heating/holding zone and the first cooling zone each comprise at least one process chamber with an inlet opening and an outlet opening for the metal strip, in particular a metallically encapsulated process chamber, for example at least one process chamber surrounded by a muffle.

In order to avoid leakage of inert gas, the process chamber of the heating/holding zone is advantageously connected to the process chamber of the first cooling zone in a gas-tight manner.

It should also be noted at this point that the invention is not limited to the embodiment of vertical furnaces with muffles, but also includes all other types of vertical furnaces, such as masonry furnaces. Slow cooling of the metal strip is made possible in that the first cooling zone is configured as a radiation cooling zone for the metal strip.

Preferably, a cooling/heating chamber through which a cooling fluid flows is arranged around the process chamber of the first cooling zone, wherein a lateral surface, which faces the cooling/heating chamber, of a wall surrounding the process chamber is acted upon by the cooling fluid.

Advantageously, the fluid is a gas or gas mixture, in particular air.

For recuperating energy and cooling the cooling fluid, at least one heat exchanger may be provided for transferring heat from the cooling fluid to another material flow. This variant of the invention is particularly suitable for a circulating cooling fluid.

Alternatively or additionally, at least one supply line for supplying fresh cooling fluid, in particular fresh air, may be provided.

In order to be able to adjust the amount of cooling fluid, at least one discharge line for discharging cooling fluid flowing out of the cooling/heating chamber from the vertical furnace may also be provided.

To generate a flow in the cooling fluid, at least one flow machine, for example a blower, may be provided.

In order to be able to better adjust the temperature of the cooling fluid, at least one heating device may be provided for heating the cooling fluid.

It has proven to be particularly advantageous for at least one temperature measuring device for measuring the temperature to be arranged in the cooling/heating chamber.

In order to record the temperatures in the cooling fluid, at least one temperature measuring device for measuring the temperature of the cooling fluid flowing out of the cooling/heating chamber and at least one temperature measurement for measuring the cooling medium flowing into the cooling/heating chamber may be provided.

An optimal process may be achieved by the vertical furnace being configured to change the temperature of the cooling medium flowing into the cooling/heating chamber as a function of at least one temperature measured in the cooling/heating chamber, and/or the flow rate of the cooling medium.

Furthermore, at least one pressure measuring device may be arranged in the cooling/heating chamber for measuring a pressure in the cooling/heating chamber.

Advantageously, the at least one second cooling zone may comprise at least one spray and/or nozzle cooling and/or jet cooling for applying cooling fluid to a surface of the metal strip.

In order not to negatively affect the inert gas atmosphere in the second cooling zone, the cooling fluid of the at least one second cooling zone may comprise or be an inert gas, in particular H₂.

In a preferred embodiment of the invention, it is provided that the first cooling zone and the second cooling zone are connected to each other in a gas-tight manner with respect to an environment of the vertical furnace at their ends facing the deflection device via a housing of the deflection device.

To prevent excessive cooling of the metal strip during deflection, the deflection device may be thermally insulated.

It has been found to be particularly advantageous that the deflection device comprises at least one heating means.

According to a preferred variant of the invention, which has proved to be particularly advantageous especially with regard to damage-free deflection, it is provided that the deflection device comprises a temperature measuring unit and a temperature control unit, wherein the temperature control unit is configured to control (closed loop) a temperature level of the deflection device to a temperature level of the metal strip by means of the at least one heating means.

In order to be able to optimally adjust the run of the metal strip, at least one roller arrangement of the deflection device may be used for center control.

In order to increase the process speed, the vertical furnace may have an additional rapid heating zone for the metal strip with at least one heating device upstream of the heating zone and/or holding zone in the conveying direction of the metal strip.

A variant of the invention, which is characterized by a very fast heating of the metal strip, consists in that the at least one heating device of the rapid heating zone is configured as an induction heater, wherein the rapid heating zone comprises a process chamber with a wall of a non-metallic material as well as an inlet opening and an outlet opening for the metal strip, wherein the process chamber of the rapid heating zone has an inert gas atmosphere with a high H₂ content of 30%-100% H₂ (vol. %) and low dew points of −20° C. to −70° C., and the induction heater is arranged outside the process chamber.

Advantageously, the process chamber of the rapid heating zone is connected to the process chamber of the heating/holding zone in a gas-tight manner with respect to the external environment of the vertical furnace.

According to an advantageous advancement of the invention, a third cooling zone may be provided, which third cooling zone is arranged downstream of the second cooling zone with respect to the conveying direction of the metal strip, wherein the third cooling zone has an inert gas atmosphere with a high H₂ content (30%-100% H₂) (vol. %) and low dew points (−20° C. to −70° C.).

In order to ensure optimum guidance of the metal strip, it may be provided that at least one dancer roller mounted in a housing is arranged in the inlet zone and/or in the outlet zone, wherein the housing in each case has an inlet opening and an outlet opening for the metal strip.

Furthermore, it has proven to be particularly advantageous that an inert gas atmosphere, in particular a hydrogen and/or nitrogen atmosphere, prevails in the interior of the housing.

In order to prevent gas from escaping from the vertical furnace on the inlet side, it may be provided that the inlet zone is connected to the rapid heating zone in a gas-tight manner with respect to the environment of the vertical furnace.

A gas escape on the outlet side may be prevented by the outlet zone being connected to a downward strand of the vertical furnace, which comprises at least the second cooling zone, in a gas-tight manner with respect to the environment of the vertical furnace.

For the purpose of better understanding of the invention, it will be elucidated in more detail by means of the figures below which relate to non-limiting exemplary embodiments.

These show in a respectively very simplified schematic representation:

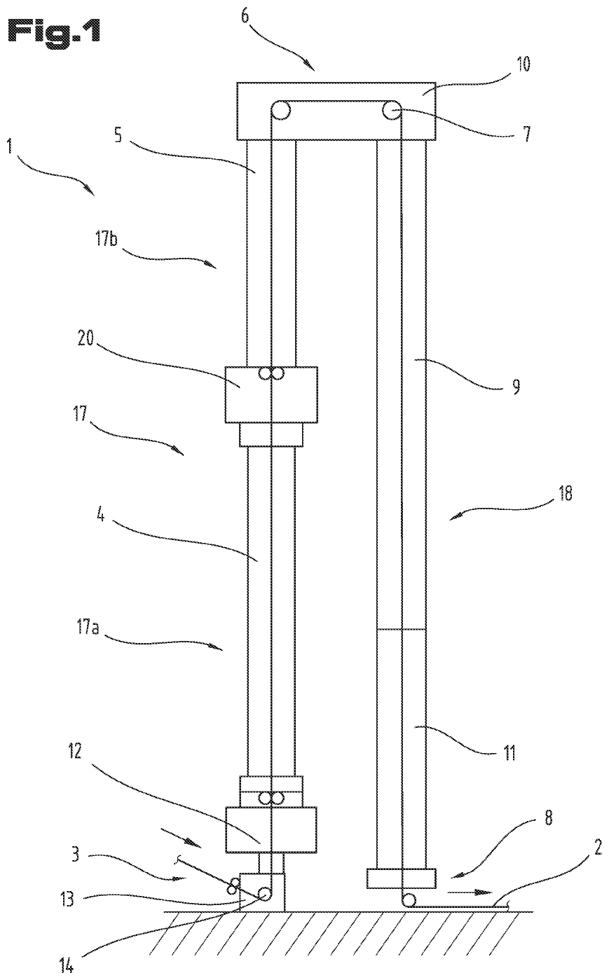

FIG. 1 a vertical furnace according to the invention;

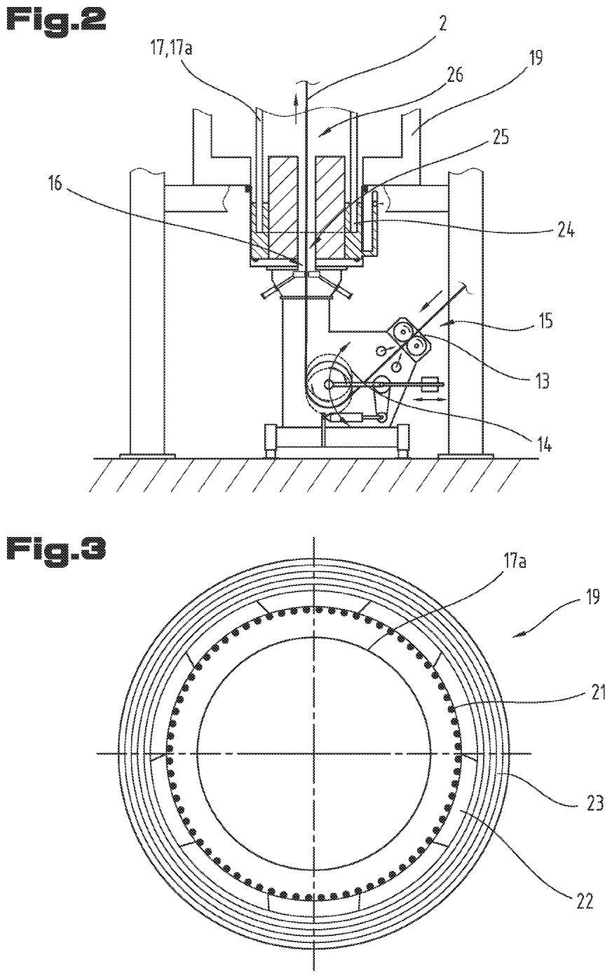

FIG. 2 a section through an inlet region of the vertical furnace;

FIG. 3 a section along the line III-III in FIG. 1;

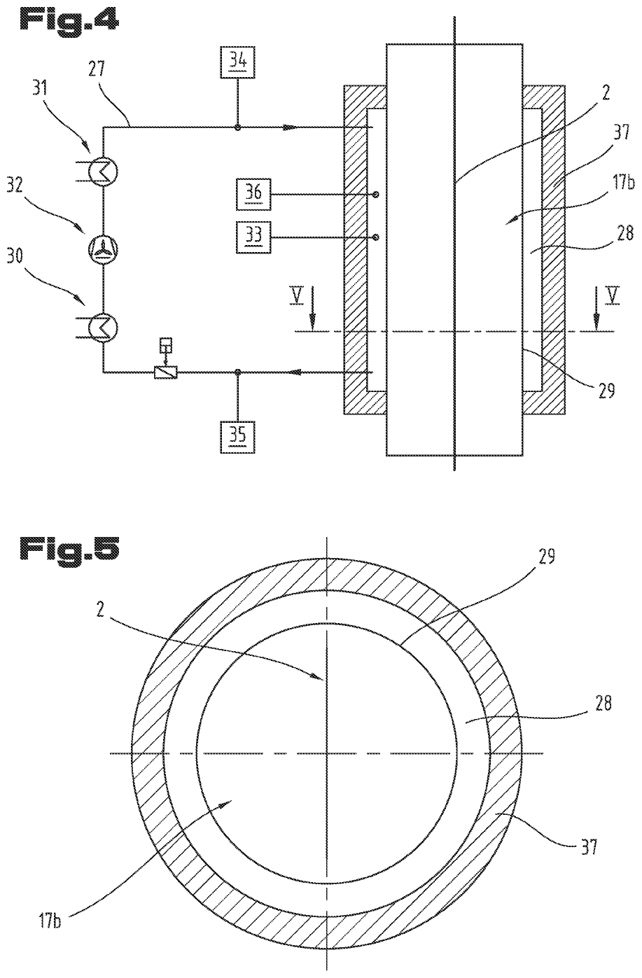

FIG. 4 the first cooling zone in closer detail;

FIG. 5 a section along the line V-V in FIG. 4.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

The figures will be comprehensively described below.

According to FIG. 1, a vertical furnace 1 for the continuous heat treatment of a metal strip 2 may have, as viewed in a conveying direction of the metal strip 2, in succession, an inlet zone 3 for the metal strip 2, a heating/holding zone 4 comprising an annealing chamber for heating and holding the metal strip 2 at a certain temperature, a first cooling zone 5 for slowly cooling the metal strip 2, a deflection device 6 arranged downstream of the first cooling zone 5 with a roller arrangement 7 with two or more rollers for deflecting the metal strip 2 in the direction of an outlet zone 8 for the metal strip 2. An embodiment of the heating/holding zone 4 and the first cooling zone 5 are described in more detail below.

Downstream of the deflection device 6, there is a second cooling zone 9, wherein the second cooling zone 9 comprises at least one cooling fluid supply unit. The cooling fluid supply unit serves to supply a cooling fluid, for example a gas or a cooling liquid, into the second cooling zone 9 for cooling the metal strip 2. The cooling fluid supply unit may comprise, for example, a spray and/or nozzle cooling and/or jet cooling. For example, nozzles may be arranged in the second cooling zone 9 through which the cooling fluid is injected to flow around the metal strip 2 in the second cooling zone 9. The cooling of the metal strip 2 in the second cooling zone 9 is preferably performed by convection. The first cooling zone 5, on the other hand, is preferably configured as a radiation cooling zone, in which the metal strip 2 is cooled by the emission of radiation. The cooling fluid may be circulated in the second cooling zone 9. In this case, a heat exchanger may also be provided for transferring heat from the cooling fluid to another material flow. The cooling fluid may, for example, be extracted from the second cooling zone and fed to the heat exchanger via a pipe and, after cooling, be blown back into the second cooling zone 9.

The heat treatment of the metal strip is carried out in an inert gas atmosphere with a high H₂ content (30%-100% H₂) and low dew points (−20° C. to −70° C.) in order to avoid oxidation. For this reason, an appropriate inert gas atmosphere is present in the heating/holding zone 4, in the first cooling zone 5, in the deflection device 6 and in the second cooling zone 9, as well as in any subsequent cooling zones. In particular, an inert gas atmosphere may be present throughout the upward strand and throughout the downward strand.

In order not to contaminate the protective gas atmosphere inside the vertical furnace 1, a protective gas, in particular a protective gas comprising H₂, may be used as the cooling fluid of the cooling zone 9.

Downstream of the second cooling zone 9, a third cooling zone 11 may be provided. With regard to the cooling zone 11, what has been stated regard the cooling zone 9 also applies mutatis mutandis. Cooling of the metal strip 2 is performed to different degrees in the three cooling zones 5, 9 and 11. A difference between the entry temperature of the metal strip 2 into the respective cooling zone 5, 9, 11 and the exit temperature on leaving the respective cooling zone 5, 9, 11 is preferably higher in the first cooling zone 5 than in the second cooling zone 9 and in the third cooling zone 11. For example, in the first cooling zone 5 the metal strip 2 may be cooled from 1020° C. to 700°, in the second cooling zone 9 from 700° C. to 600° C. and in the third cooling zone 11 from 600° C. to 60° C. The values indicated above are to be understood as examples and may vary in practice.

In the deflection device 6, the temperature may be constant compared to the first cooling zone 5. As can be seen from FIG. 1, the deflection device 6 and/or the roller arrangement 7 can reverse the conveying direction of the metal strip 2 in the second cooling zone 9 compared to the first cooling zone 5. In particular, the deflection device 6 and/or the roller arrangement 7 may deflect the conveying direction of the metal strip by 180°.

The first cooling zone 5 and the second cooling zone 9 are connected to each other in a gas-tight manner with respect to an environment of the vertical furnace 1 via a housing 10 of the deflection device 9 at their ends facing the deflection device 6. Via the housing 10, the cooling zone 5 and the cooling zone 9 may also be in a flow connection and/or be connected to each other in terms of gas. Thus, the first cooling zone 5 and the second cooling zone 9 as well as the housing 10 of the deflection device form a common space. The deflection device 9 represents a connection, also in terms of gas technology, between an upward strand 17 comprising the heating/holding zone 4 and the first cooling zone 5 and a downward strand 18 comprising the cooling zone 9 and possibly further cooling zones, of the vertical furnace 1.

The deflection device 6 may be thermally insulated and comprise one or more heating means and a temperature control unit to enable the temperature of the deflection device 6 to be adjusted and/or controlled (closed loop). The heating means of the deflection device may be electric or gas powered. The deflection of the metal strip 2 takes place at an elevated temperature between 300° C.-1000° C. The temperature control unit is configured to adjust a temperature level of the deflection device 9 to a temperature level of the metal strip 2 by means of the at least one heating means. By means of the deflection device, the metal strip 2 is deflected without damage at an elevated strip temperature and in an ultra-pure inert gas atmosphere with a hydrogen content of between 30% and 100% and a dew point of between −20° C. to −70° C.

Furthermore, the roller arrangement 7 of the deflection device 6 may have center-regulated deflection rollers in order to center the metal strip.

A rapid heating zone 12 with a heating device may be arranged upstream of the heating/holding zone 4. Preferably, the heating device of the rapid heating zone 12 is configured as an induction heater and serves for the rapid heating of the metal strip 2. The rapid heating zone 12 comprises a process chamber with a wall of a non-metallic material as well as an inlet opening and an outlet opening for the metal strip. The process chamber may be realized with a muffle. In the process chamber of the rapid heating zone 12, an inert gas atmosphere with a high H₂ content of 30%-100% H₂ and low dew points of −20° C. to −70° C. is present. At least one inductor is arranged outside the process chamber of the rapid heating zone 12. In this regard, the process chamber may be enclosed by the inductor. The inductor may be configured as a transverse field or longitudinal field inductor. In addition, the process chamber of the rapid heating zone 12 is connected in a gas-tight manner, with respect to the outer environment of the vertical furnace, to the process chamber of the heating/holding zone 4 and to the elements upstream of the rapid heating zone. There are thus gas-tight connecting pieces between the process chamber (muffle) of the rapid heating zone 12 and the upstream/downstream elements. The process chamber of the rapid heating zone 12 is connected to the process chamber of the heating/holding zone 4 in terms of construction and protective gas. The inlet zone 3 is also connected to rapid heating zone 12 in a gas-tight manner with respect to an environment of the vertical furnace 1.

In addition, an integration of the rapid heating zone 12 into a higher-level safety system of the vertical furnace 1 may also be realized. The use of the inductor enables a fast heating of the metal strip 2 and a substantial increase in throughput.

Furthermore, at least one dancer roller 14 mounted in a housing 13 may be arranged in each case in the inlet zone 3 and/or the outlet zone 4. According to FIG. 2, the housing 13 may have an inlet opening 15 and an outlet opening 16 for the metal strip 2. An inert gas atmosphere, in particular a hydrogen and/or nitrogen atmosphere, may be present in the interior of the housing 13.

According to FIG. 1, at least one sealing device 24 and/or 8 is arranged at an end section facing away from the deflection device 6 of the upward strand 17 and/or of the downward strand 18 for sealing against the ambient atmosphere. Thus, the inlet zone 3 is connected to the upward strand 17 and the outlet zone 4 is connected to the downward strand 18 of the vertical furnace 1 in a gas-tight manner with respect to an environment of the vertical furnace 1. According to FIG. 3, the sealing device 24 may have an inlet opening 25 and an outlet opening 26 for the metal strip 2. Preferably, the sealing device 24 is configured as an oil seal. The sealing device 24 may be directly connected to the housing 13.

As can further be seen from FIG. 1, the vertical furnace 1 may have a first tubular muffle 17a and a second tubular muffle 17b within which the metal strip 2 is guided. In this regard, the interior of the muffle 17a represents the process chamber of the heating/holding zone 4 and the muffle 17b represents the process chamber of the cooling zone 5. The coupling device 20 is arranged between the first muffle 17a and the second muffle 17b and connects the two muffles 17a and 17b at their ends. The heating/holding zone 4 is arranged along the first muffle 17a, the first cooling zone 5 along the second muffle 17b, while the second cooling zone 9 and the third cooling zone 11 are arranged in the downward strand 18. A protective gas atmosphere, in particular a hydrogen atmosphere, with a high H2 content (30%-100% H2) and low dew points (−20° C. to −70° C.), may be present in the first muffle 17a and in the second muffle 17b, as well as in the deflection device 6 and the second cooling zone 9 and the third cooling zone 11, in order to prevent oxidation. In this context, the vertical furnace 1 may comprise, for example, a gas supply unit, in particular a hydrogen supply unit, connected to the interior of the first muffle 17a and/or to the interior of the second muffle 17b. Furthermore, a device for determining particles in the atmosphere inside the muffles 17a, 17b, deflection device 6, second cooling zone 9, third cooling zone 11 may be provided.

As can be seen from FIG. 3, a thermal insulation 19 may further be provided to insulate the first muffle 17a and/or the second muffle 17b. The rapid heating zone 12 may be arranged upstream of the first muffle 17a and connected thereto in a gas-tight manner with respect to the external atmosphere.

The heating/holding zone 4 may be arranged along the muffle 17a and the first cooling zone 5 may be arranged along the muffle 17b. The two muffles 17a and 17b may be connected to each other by a coupling device 20.

In the heating/holding zone 4, one or more electrical heating elements 21 may be arranged on an outer lateral surface of the first muffle 17a, in particular running in the circumferential direction along the muffle 17a, as shown in FIG. 3. The heating element 21 may be arranged between the thermal insulation 19 and the muffle 17a. Furthermore, the heating element 21 may be surrounded by a fireproof layer 22, for example of a layer of vacuum-formed bricks. In this case, the heating element 21 is arranged between the at least one first muffle 17a and the fireproof layer 22. Moreover, at least one layer 23 of a fibrous material, for example a non-woven fabric, a knitted fabric, a woven fabric, a mesh or felt, may be arranged on the fireproof layer 22. In this regard, the fireproof layer 22 is arranged between the at least one heating element 21 and the at least one layer 23 of fibrous material.

FIGS. 4 and 5 show the closer structure of the cooling zone 5 of the upward strand. The cooling zone 5 is configured as a slow radiation cooling zone, in which the metal strip is cooled only by the emission of thermal radiation relative to a cooled wall 29 of the muffle 17b. Inside the muffle 17b, i.e. in the process chamber of cooling zone 5, there is an inert gas atmosphere with a high H₂ content of 30%-100% H₂ and low dew points of −20° C. to −70° C. The cooling zone 5 has a process chamber configured as a muffle 17b which is gas-tight with respect to the outer atmosphere of the vertical furnace 1. However, the muffle 17b may be connected to the muffle 17a and the deflection device 10 and the downward strand 18 in terms of inert gas, such that at least a slight exchange of inert gas between these areas is possible.

A cooling/heating chamber 28 through which a cooling fluid 27 flows is arranged around the process chamber of the first cooling zone 5. The cooling/heating chamber 28 is bounded by the wall 29 of the muffle 17b and an outer insulated housing 37. A lateral surface of the wall 29 of the muffle 17b surrounding the process chamber facing the cooling/heating chamber 28 is acted upon by the cooling fluid 27. The cooling fluid 27, which is preferably a gas or gas mixture, for example air, N₂ or other gases or gas mixtures, thus cools the muffle 17b from the outside. The hot metal strip 2 releases its energy in the form of radiation via the cooled muffle wall.

The cooling fluid 27 may be passed through a heat exchanger 30 to recuperate heat from the cooling fluid 27 flowing out of the cooling/heating chamber 28 and cool the cooling fluid 27. However, as an alternative or in addition to the use of a heat exchanger, fresh cooling fluid 27, for example in the form of fresh air, may be fed into the cooling fluid flow via a supply line and blown into the cooling/heating chamber 28 for cooling the muffle wall.

Furthermore, a discharge line may be provided for discharging cooling fluid 27 flowing out of the cooling/heating chamber. A flow machine 32, in particular a blower, is provided for generating a flow in the cooling fluid 27.

Furthermore, a heating device 31 may be provided for heating the cooling fluid 27. By means of the heating device 31, the temperature of the cooling fluid 27 may be changed in accordance with the given process requirements and thus the cooling behavior of the metal strip 2 in the cooling zone 5 may be specifically intervened in. The cooling and heating system may be divided into one or more control zones along the length of the muffle 17b. The cooling/heating system of the cooling zone 5 also enables a temperature of the metal strip to be maintained in this zone.

Furthermore, a temperature measuring device 33 for measuring the temperature in the cooling/heating chamber 28 and a temperature measuring device 34 for measuring the temperature of the cooling fluid 27 flowing out of the cooling/heating chamber 28 and a temperature measuring device 35 for measuring the cooling fluid 27 flowing into the cooling/heating chamber 28 may be provided. The vertical furnace 1 and/or a furnace controller, for example an accordingly programmed processor, may be arranged to change the temperature of the cooling fluid 27 flowing into the cooling/heating chamber 28 as a function of a temperature measured in the cooling/heating chamber 28 and/or the flow rate of the cooling fluid 27.

Furthermore, in addition to temperature control, pressure control of the cooling system may also be performed. For this purpose, a pressure measuring device 36 for measuring a pressure may also be arranged in the cooling/heating chamber 28.

The particular embodiment of the cooling zone 5 allows for a slow and uniform cooling of the metal strip 2 in an ultra-pure inert gas atmosphere (30% to 100% H2, dew point −20° C. to −70° C.).

Finally, as a matter of form, it should be noted that for ease of understanding of the structure, elements are partially not depicted to scale and/or are enlarged and/or are reduced in size.

### LIST OF REFERENCE NUMBERS

| | |
|---|---|
| 1 | Vertical furnace |
| 2 | Metal strip |
| 3 | Inlet zone |
| 4 | Heating/holding zone |
| 5 | Cooling zone |
| 6 | Deflection device |
| 7 | Roller arrangement |
| 8 | Outlet zone |
| 9 | Cooling zone |
| 10 | Housing |
| 11 | Cooling zone |
| 12 | Rapid heating zone |
| 13 | Housing |
| 14 | Dancer roller |
| 15 | Inlet opening |
| 16 | Outlet opening |
| 17 | Upward strand |
| 17a | First muffle |
| 17b | Second muffle |
| 18 | Downward strand |
| 19 | Insulation |
| 20 | Coupling |
| 21 | Heating element |
| 22 | Layer |
| 23 | Material |
| 24 | Sealing device |
| 25 | Inlet opening |
| 26 | Outlet opening |
| 27 | Cooling fluid |
| 28 | Cooling/heating chamber |
| 29 | Wall |
| 30 | Heat exchanger |
| 31 | Heating device |
| 32 | Flow machine |
| 33 | Temperature measuring device |
| 34 | Temperature measuring device |
| 35 | Temperature measuring device |
| 36 | Pressure measuring device |
| 37 | Insulated housing |

1: A vertical furnace (1) for the continuous heat treatment of a metal strip (2), in particular an electrical steel strip, wherein the vertical furnace (1), as seen in a conveying direction of the metal strip (2), comprises:
an inlet zone (3) for the metal strip (2);
a heating/holding zone (4) with an annealing chamber for heating and holding the metal strip (2) at a certain temperature;
at least one first cooling zone (5) for cooling the metal strip (2);
at least one deflection device (6) arranged downstream of the first cooling zone (5) for deflecting the metal strip (2) in the direction of an outlet zone (8) for the metal strip (2),
wherein at least one second cooling zone (9) is arranged downstream of the deflection device (6) with respect to the conveying direction, wherein the first cooling zone (5) is configured as a radiation cooling zone for the metal strip, wherein a cooling/heating chamber (28) through which a cooling fluid (27) flows is arranged around the process chamber of the first cooling zone (5), wherein a lateral surface, which faces the cooling/heating chamber (28), of a wall (29) surrounding the process chamber is acted upon by the cooling fluid (27).

2: The vertical furnace according to claim 1, wherein the vertical furnace has a protective gas atmosphere with a high H₂ content of 30%-100% H2 and low dew points of −20° C. to −70° C., at least in the heating/holding zone (4), in the first cooling zone (5), in the deflection device (6) and in the second cooling zone (9) for heat treatment of the metal strip, in order to avoid oxidation.

3: The vertical furnace according to claim 1, wherein the heating/holding zone (4) and the first cooling zone (5) each comprise at least one process chamber with an inlet opening and an outlet opening for the metal strip, in particular a metallically encapsulated process chamber, for example at least one process chamber surrounded by a muffle (17a, 17b).

4: The vertical furnace according to claim 3, wherein the process chamber of the heating/holding zone (4) is connected to the process chamber of the first cooling zone (5) in a gas-tight manner.

5-6. (canceled)

7: The vertical furnace according to claim 1, wherein the cooling fluid (27) is a gas or a gas mixture, in particular air.

8: The vertical furnace according to claim 1, wherein the cooling fluid (27) is passed through a heat exchanger (30).

9: The vertical furnace according to claim 1, wherein the vertical furnace comprises at least one supply line for supplying fresh cooling fluid, in particular fresh air.

10: The vertical furnace according to claim 9, wherein the vertical furnace comprises at least one discharge line for discharging cooling fluid flowing out of the cooling/heating chamber from the vertical furnace (1).

11: The vertical furnace according to claim 1, wherein the vertical furnace comprises at least one flow machine (32), in particular a blower, for generating a flow in the cooling fluid (27).

12: The vertical furnace according to claim 1, wherein at least one heating device (31) for heating the cooling fluid (27) is provided.

13: The vertical furnace according to claim 1, wherein the vertical furnace comprises at least one temperature measuring device (33) for measuring the temperature in the cooling/heating chamber (28).

14: The vertical furnace according to claim 1, wherein the vertical furnace comprises at least one temperature measuring device (34) for measuring the temperature of the cooling fluid (27) flowing out of the cooling/heating chamber (28) and at least one temperature measuring device (35) for measuring the cooling fluid (27) flowing into the cooling/heating chamber (28).

15: The vertical furnace according to claim 13, wherein the vertical furnace is configured to change the temperature of the cooling medium (27) flowing into the cooling/heating chamber (28) as a function of at least one temperature measured in the cooling/heating chamber (28), and/or the flow rate of the cooling medium (27).

16: The vertical furnace according to claim 1, wherein at least one pressure measuring device (36) for measuring a pressure in the cooling/heating chamber (28) is arranged in the cooling/heating chamber (28).

17: The vertical furnace according to claim 1, wherein the at least one second cooling zone (9) comprises at least one spray and/or nozzle cooling and/or jet cooling for applying cooling fluid to a surface of the metal strip.

18: The vertical furnace according to claim 17, wherein the cooling fluid of the at least one second cooling zone (9) comprises or is an inert gas, in particular H₂.

19: The vertical furnace according to claim 1, wherein the first cooling zone (5) and the second cooling zone (9) are connected to each other in a gas-tight manner with respect to an environment of the vertical furnace at their ends facing the deflection device (6) via a housing (10) of the deflection device (6).

20: The vertical furnace according to claim 1, wherein the deflection device (6) is thermally insulated.

21: The vertical furnace according to claim 1, wherein the deflection device (6) comprises at least one heating means.

22: The vertical furnace according to claim 21, wherein the deflection device (6) comprises a temperature measuring unit and a temperature control unit, wherein the temperature control unit is configured to adjust a temperature level of the deflection device to a temperature level of the metal strip (2) by means of the at least one heating means.

23: The vertical furnace according to claim 1, wherein at least one roller arrangement (7) of the deflection device (6) is configured for center control of the metal strip.

24: The vertical furnace according to claim 1, wherein the vertical furnace comprises an additional rapid heating zone (12) for the metal strip with at least one heating device upstream of the heating/holding zone (4) in the conveying direction of the metal strip (2).

25: The vertical furnace according to claim 24, wherein the at least one heating device of the rapid heating zone (12) is configured as an induction heater, wherein the rapid heating zone (12) comprises a process chamber with a wall (29) of a non-metallic material as well as an inlet opening and an outlet opening for the metal strip (2), wherein the process chamber of the rapid heating zone (12) has an inert gas atmosphere with a high H2 content of 30%-100% H2 and low dew points of −20° C. to −70° C., and the induction heater is arranged outside the process chamber.

26: The vertical furnace according to claim 25, wherein the process chamber of the rapid heating zone (12) is connected to the process chamber of the heating/holding zone (4) in a gas-tight manner with respect to the external environment of the vertical furnace (1).

27: The vertical furnace according to claim 1, wherein a third cooling zone (11) is provided, which third cooling zone (11) is arranged downstream of the second cooling zone with respect to the conveying direction of the metal strip, wherein the third cooling zone (11) has an inert gas atmosphere with a high H2 content (30%-100% H2) and low dew points (−20° C. to −70° C.).

28: The vertical furnace according to claim 1, wherein in each case at least one dancer roller (14) mounted in a housing (13) is arranged in the inlet zone (3) and/or in the outlet zone (4), wherein the housing (13) in each case comprises an inlet opening (15) and an outlet opening (16) for the metal strip (2) and an inert gas atmosphere, in particular a hydrogen and/or nitrogen atmosphere, is present in the interior of the housing (13).

29: The vertical furnace according to claim 24, wherein the inlet zone (3) is connected to the rapid heating zone (12) in a gas-tight manner with respect to an environment of the vertical furnace (1).

30: The vertical furnace according to claim 1, wherein the outlet zone (4) is connected to a downward strand of the vertical furnace (1), which comprises at least the second cooling zone (9), in a gas-tight manner with respect to an environment of the vertical furnace (1).
